(19) United States
(12) Patent Application Publication
(10) Pub. No.: US 2025/0352974 A1
(43) Pub. Date: Nov. 20, 2025

(54) MICRO-FLOW SYNTHESIS OF COMPOUNDS AND SYSTEMS THEREOF

(71) Applicant: National University of Singapore, Singapore (SG)

(72) Inventors: Jie WU, Singapore (SG); Chenguang LIU, Singapore (SG); Mu WANG, Singapore (SG)

(73) Assignee: National University of Singapore, Singapore (SG)

(21) Appl. No.: 19/117,056

(22) PCT Filed: Oct. 4, 2023
(86) PCT No.: PCT/SG2023/050670

§ 371 Date: Mar. 30, 2025

(30) Foreign Application Priority Data
Oct. 5, 2022 (SG) 10202251278Y

(51) Int. Cl. B01J 19/00

(52) U.S. Cl. CPC B01J 19/0093; B01J 2219/00792; B01J 2219/00831; B01J 2219/00833; B01J 2219/00835; B01J 2219/00934

(57) ABSTRACT

The present disclosure concerns a micro-flow system for synthesis of a compound, comprising a tubing reactor configured to flow a reactant within its lumen thereof, an actuator for regulating the flow of the reactant in the lumen and a heterogeneous catalyst in fluid communication with the lumen. The present disclosure also concerns a method of micro-flow synthesising a compound using the micro-flow system.

### TECHNICAL FIELD

The present invention relates, in general terms, to a method of synthesising compounds using micro-flow techniques and a system for synthesising compounds. The method and system can be automated.

### BACKGROUND

There are several developments of flow synthesis technologies applicable for heterogeneous photocatalysis at gram-scale. However, in the context of larger scale production, the challenges that remain include clogging issues and mismatch with the long reaction time. Furthermore, the majority of commercialised flow setups are specialized with considerable equipment investment, which are difficult to be customized on demand. Even though continuous-flow synthesis in micro-tubing reactors has provided enormous opportunities for photochemical synthesis especially benefiting the scaling up processes, handling solids and slow reactions are still big hurdles which hampered its wide application.

There has also been development for photocatalysis in the past decade. Photo-harvesting catalysts can promote single-electron transfer (SET), energy transfer, or hydrogen atom transfer (HAT) to access reactive open-shell species or pump to energy uphill intermediates, enabling tremendous opportunities to assemble molecules in a mild, green, and effective manner. Even though conventional batch photochemical reactors are still chosen for reaction development due to low cost, ease of screening, operation, and reaction monitorization, continuous-flow reactors have received more attention for scaling-up of photochemical reactions as a critical outcome of the Beer-Lambert Law. Only the proximal area (e.g., within 2 mm) of the vessel wall may be effectively irradiated by visible-light, making it difficult to employ dimension-enlarging strategy for scaling up reactions in conventional batch reactors. In contrast, in a continuous micro-reactor, uniform and effective light irradiation may be achieved with the narrow diameter tubing or micro-channels. Other advantages of continuous micro-flow reactors include the improved mass/heat transfer, enhanced safety, precise control of reaction parameters, and ease of scaling up, which normally enable reaction acceleration and lower photocatalyst loadings.

Despite the advantages with continuous-flow reactors, they are difficult to be applied to slow reactions which require extensive length of tubing reactors that increases the risks of pressure drop, clogging, and infrastructure complication. Moreover, heterogeneous photocatalysis remains challenging in a continuous-flow reactor due to the risks of clogging (FIG. 6).

Several flow synthesis technologies have been designed to overcome these problems. FIG. 1 shows some examples of flow synthesis that are currently used.

FIG. 1a shows a packed bed reactor applied with a heterogeneous photocatalyst for synthesising compounds. However, heavy loading of catalysts and padding for scale up can lead to a sharp increase of back pressure. Additionally, the inevitable accumulation of deep-color stain in the bed can poison the catalyst, weaken the light intensity. Even though packed-bed reactors are commonly utilized for heterogeneous catalysis, the opaque character of solid photocatalysts limit their usage to only capillary reactors or pre-modified glass bead-supported photocatalysis.

FIG. 1b shows continuous stirred tank reactors (CSTRs) being applied to synthesis compounds. CSTRs have been applied to heterogeneous photocatalysis to achieve gram-scale synthesis. However, CSTR possesses a poor residence time distribution (RTD), especially when the vessel size is large.

FIG. 1c shows oscillatory flow reactors being applied to heterogeneous photocatalytic synthesis of compounds at a gram scale. Oscillatory flow reactors represent a potentially practical technology for heterogeneous photocatalysis, even with slow reactions. Gram to hundred-gram scale synthesis has been demonstrated in these systems. However, a compromise between efficient particle suspension and narrow RTD has to be achieved through optimization, the window of which is relatively narrow.

FIG. 1d shows a Serial Micro-Batch Reactor, which can be used in heterogeneous photocatalyzed fluorination reactions. A gas-liquid-solid system may be used to achieve serial micro-batch reactors. However, the maximum processing capability is limited and cannot be readily scaled up, with only gram-scale production obtained.

FIG. 1e shows a rotor-stator spinning disk reactor (pRS-SDR), which can only be used for specific reactions such as organic dye photodegradation in a heterogeneous fashion, and requires precise fine-tuning.

Most of the developed reactors gave only small production rate, just suitable for short residence time reaction, due to the limited reactor volume. Furthermore, the majority of them are specialized with considerable equipment investment, which are difficult to customize on demand.

It would be desirable to overcome or ameliorate at least one of the above-described problems.

### SUMMARY

The present invention provides a micro-flow system for synthesis of a compound, comprising:
a) a tubing reactor configured to flow a reactant within its lumen thereof;
b) an actuator for regulating the flow of the reactant in the lumen; and
c) a heterogeneous catalyst in fluid communication with the lumen;

wherein the heterogeneous catalyst is configured to flow in tandem with the reactant in order to catalyse the reactant to form the compound; and

wherein the reactant and the heterogeneous catalyst are configured to flow within the lumen of the tubing reactor for more than one cycle.

In some embodiments, the micro-flow system is formable as a closed loop.

In some embodiments, the tubing reactor is characterised by a volume of about 50 ml to about 1000 mL.

In some embodiments, the tubing reactor is characterised by a volume of about 90 mL to about 850 mL.

In some embodiments, the tubing reactor is characterised by an inner diameter of about 1 mm to about 10 mm.

In some embodiments, the tubing reactor is characterised by an inner diameter of about 5 mm.

In some embodiments, the tubing reactor comprises a tubing, the tubing comprising a material selected from perfluoroalkoxy alkane (PFA), ethylene-tetra-fluoro-ethylene (ETFE), poly (ether-ether-ketone) (PEEK), poly-tetra-fluoroethylene (PTFE), polyvinylidene difluoride (PVDF), fluorinated ethylene propylene (FEP, Teflon®), stainless steel (SS), Viton®, Norprene®, silicon carbide (SIC), EPDM rubber, glass, or a combination thereof.

In some embodiments, the actuator is a peristaltic pump.

In some embodiments, the heterogeneous catalyst is selected from mesoporous graphitic carbon nitride, insoluble inorganic salts/oxide powders such as titanium dioxide, immobilized heavy metals such as palladium on carbon, single-atom catalysts such as single-atom palladium distributed in titanium dioxide, catalysts immobilized on resin such as resin supported enzymes, inorganic nanoparticles, conjugated microporous polymers (CMP), covalent organic frameworks (COFs), metal organic frameworks (MOFs), hydrogen-bonded organic frameworks (HOFs), or a combination thereof.

In some embodiments, the heterogeneous catalyst is characterised by a particle size of about 10 nm to about 10 mm.

In some embodiments, the heterogeneous catalyst is characterised by a concentration of about 20 mg/mL to about 200 mg/mL.

In some embodiments, the heterogeneous catalyst is dispersed on a solid support.

In some embodiments, the solid support is characterised by a catalyst loading of about 1 wt/wt % to about 10 wt/wt %.

In some embodiments, the system further comprises a homogeneous catalyst.

In some embodiments, the tubing reactor is coupled to a light source for photocatalysing the reactant in the presence of the heterogeneous catalyst.

In some embodiments, the heterogeneous catalyst is a heterogeneous photocatalyst.

In some embodiments, the light source is positioned adjacent to a longitudinal axis of the tubing reactor.

In some embodiments, the light source is a LED.

In some embodiments, the light source is configured to provide at least 300 W of light to the tubing reactor.

In some embodiments, the micro-flow system further comprises a controller configured to regulate the flow of the reactant and the heterogeneous catalyst.

In some embodiments, the micro-flow system further comprises a reaction reservoir for collecting the reactant and heterogeneous catalyst from the tubing reactor and re-circulating the reactant and heterogeneous catalyst back to the tubing reactor.

In some embodiments, the micro-flow system further comprises a collection reservoir for collecting the compound.

In some embodiments, the micro-flow system further comprises at least one multi-port valve for controlling the flow to the reaction reservoir or the collection reservoir.

In some embodiments, the micro-flow system further comprises a separator for separating the compound from the heterogeneous catalyst.

In some embodiments, the micro-flow system further comprises a reactant source, a solvent source, a heterogeneous catalyst source, gas source or a combination thereof.

In some embodiment, the micro-flow system is adaptable to withstand a flow rate of about 20 mL/min to about 1000 mL/min.

In some embodiments, the micro-flow system is adaptable to catalyse a C-N coupling, C-S coupling and/or Minisci reaction.

The present invention also provides a method of micro-flow synthesising a compound using a micro-flow system, the micro-flow system comprising:
a) a tubing reactor configured to flow a reactant within its lumen thereof;
b) an actuator for regulating the flow of the reactant in the lumen; and
c) a heterogeneous catalyst in fluid communication with the lumen;

wherein the heterogeneous catalyst is configured to flow in tandem with the reactant in order to catalyse the reactant to form the compound; and

wherein the reactant and the heterogeneous catalyst are configured to flow within the lumen of the tubing reactor for more than one cycle;
the method comprising:
a) flowing the reactant at a flow rate of about 20 mL/min to 1000 mL/min; and
b) catalysing the reactant in the presence of the heterogeneous catalyst in order to synthesise the compound.

In some embodiments, the flow rate of the reactant about 20 mL/min to about 1000 mL/min.

In some embodiments, the heterogeneous catalyst is characterised by a flow rate of about 20 mL/min to about 1000 mL/min.

In some embodiments, the flow rate of the reactant relative to the heterogeneous catalyst is about 1.01 to about 10.

In some embodiments, the method is adaptable to catalyse a C-N coupling, C-S coupling and/or Minisci reaction.

### BRIEF DESCRIPTION OF THE DRAWINGS

Embodiments of the present invention will now be described, by way of non-limiting example, with reference to the drawings in which:

FIG. 1 shows the current “state of the art” approaches to combine heterogeneous photocatalysis with continuous-flow.

FIG. 2 shows a schematic of a circulated flow reactor.

FIG. 3 shows examples of circulation flow reactors with different tubing inner diameter.

FIG. 4 shows parameter optimization results. (a) Evaluation of flow rates. (b) Tubing inner diameter. Evaluation of tubing sizes. Other conditions: 10 g Substrate in 100 ml DMA, 5% w/w mpgC₃N₄, 5% mmol [Ni],80 mL/min,64 W*9. (c) Study of concentration and catalyst loading. Other conditions: 10 g Substrate in 100 mL DMA, 5% w/w mpgC₃N₄, 5% mmol [Ni], 4.8 mm I′D′, 64 W*9. (d) Light Intensity. Other conditions: 8-hour continuous running, 10 g Substrate in 100 mL DMA, 5% w/w mpgC₃N₄, 5% mmol [Ni], 80 mL/min, 4.8 mm I'D′. \tilde{v}=flow velocity; SM=1-bromo-4-(trifluoromethyl)benzene; [PC]=mpg-CN; [Ni]=NiCl₂.glyme. Yields and conversions were based on analysis of GC measurement of the crude reaction mixtures.

FIG. 5 shows a flow synthesis for heterogenous photocatalysis in large scale. (d) 100 gram-scale photocatalytic C-N coupling in a circulation flow reactor and a batch reactor and kilogram-scale C-N coupling by recycling the same batch of photocatalyst. (e) 100 gram-scale photocatalytic C-S coupling to synthesize bipenamol precursor in batch and circulation flow reactors. (f) Photo-mediated gas/liquid/solid three-phase trifluoromethylation to generated trifluridine in batch and circulation flow reactors at a 100-gram-scale. Yields and conversions were based on analysis of GC measurement of the crude reaction mixtures.

FIG. 6 shows a reactor setup for photochemical synthesis (BPR=back pressure regulator).

FIG. 7 shows an automated kilogram scale synthesis of trifluridine. (a) Kilogram scale synthesis of trifluridine through automated continuous 10 batches of circulation flow syntheses. (b) Schematic illustration of continuous circulation flow synthesis with automated feeding and collection. (c) The setup of the automated circulation flow platform for kilogram scale synthesis.

FIG. 8 shows a two-position valve for both homogeneous reactions and heterogeneous reactions, including gas-liquid, solid-liquid or gas-solid-liquid reactions.

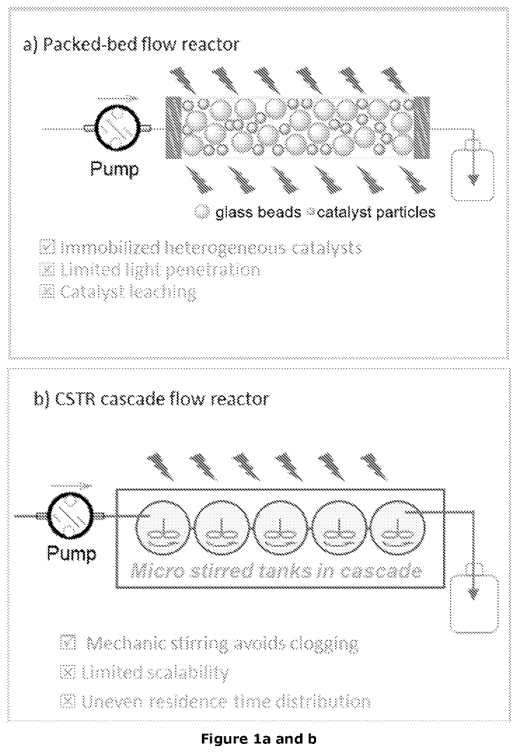

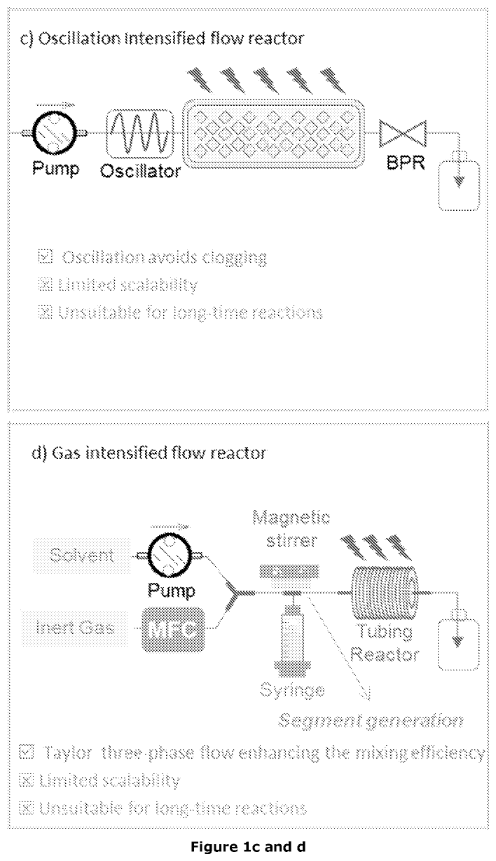

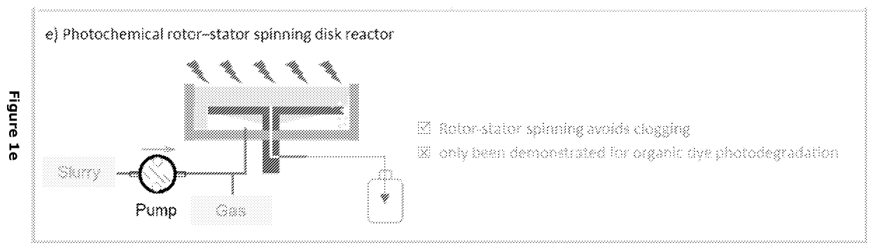

### DETAILED DESCRIPTION

The present invention is predicated on the understanding that micro flow synthesis may be met with many hurdles that limit the type, yield and purity of compound that is synthesised. These include solvent and reagent incompatibility between individual steps, cumulated by-product formation, risk of clogging, and mismatch of time scales between steps in a processing chain. Accordingly, the inventors have developed a circulation flow reactor, which was tested to be effective for heterogeneous catalysis synthesis up to kilogram scale. The flow reactor may achieve a high flow rate with high mixing efficiency as well as avoid the tubing being clogged by heterogeneous catalysts or reagents via solid sedimentation. Moreover, the feeding-processing-collecting operations may be automated by programming the control of the circulation flow reactor. It is envisioned that a general, simple, customizable and easily scalable system that is effective for heterogeneous photocatalysis is highly desirable.

In particular, 100 g-scale C-N and C-S cross-couplings through merging heterogeneous photocatalyst mpg-CN and a nickel catalyst may be acheived. The photocatalyst may be recycled and reused for 10 times without obvious deactivation, to achieve kg-scale synthesis. Even though the reaction become batchwise, continuous production may be achieved via automated feeding and collection, and a photo-promoted gas/liquid/solid three-phase trifluoromethylation reaction was performed to produce drug trifluridine at a kg-scale. This suggests that the circulation flow reactor with high flow speeds may simplify infrastructures, is easy to operate and automate, and may significantly improve efficiency compared to conventional batch reactors. It is also scalability, may improve safety and tolerance of solids.

Accordingly, the present invention provides a micro-flow system for synthesis of a compound, comprising:
a) a tubing reactor configured to flow a reactant within its lumen thereof;
b) an actuator for regulating the flow of the reactant in the lumen; and
c) a heterogeneous catalyst in fluid communication with the lumen;

wherein the heterogeneous catalyst is configured to flow in tandem with the reactant in order to catalyse the reactant to form the compound; and

wherein the reactant and the heterogeneous catalyst are configured to flow within the lumen of the tubing reactor for more than one cycle.

The present system allows for easier automation of reaction processes. It also allows for more efficient reactions due to the high flow rate. It also avoid solid clogging issues in continuous-flow synthesis.

Microfluidics refers to the behaviour, precise control, and manipulation of fluids that are geometrically constrained to a small scale (typically sub-millimeter) at which surface forces dominate volumetric forces. When microfluidics is applied to synthesis of compounds, it is termed micro-flow synthesis. Micro-flow synthesis has many advantages over conventional batch synthesis. Precise control of short reaction times (<1 sec) can be achieved. Control over the short reaction times can be achieved by fast mixing in a micro mixer, thanks to its short diffusion length and generation of turbulence flow. The reaction temperature can be precisely controlled, such that the large surface-to-volume ratio of a micro-flow reactor enables rapid heat transfer for precise reaction temperature control. In combination, it enable the use of highly reactive and unstable chemical species in organic synthesis. Further, light penetration efficiency in photochemical reactions is higher than that in batch synthesis. According to the Lambert-Beer law, the intensity of light decreases exponentially with the length of the light path. The thinness of a micro-flow photoreactor thus improves the light-penetration efficiency. The risks involved in handling dangerous compounds can be minimized as a micro-flow reactor has a small reaction space, which allows only a small amount of compounds and minimizes the risks involved in treating explosive and/or toxic compounds. Scale-up can readily be achieved, by either continuous operation or by increasing the number of reactors. Catalyst poisoning by reaction products can be avoided as reaction products are continuously removed from the reaction space in micro-flow synthesis.

Compared with continuous-flow reactors of terminating the reaction flowing at one end, in the present setup, the reaction mixture may be optionally circulated back to a reaction reservoir to re-enter the tubing reactor until the reaction reaches completion. It thus maintains all the benefits associated with micro-tubing reactors, such as the excellent light penetration, improved mass and heat transfer, and enhanced safety. Additionally, compared to continuous-flow reactors, the reaction becomes batchwise, and the reaction time is not limited to the reactor volume, which can be performed as long as needed, thus allowing for slow reactions being performed in a flow mode. Even though the reaction scale is somehow limited by the tubing volume, new sets of reagents and staring materials may be added into the reservoir to start another batch, easily achieving continuous production via automated feeding and collection. Since the system is compact and modular, the scale can also be further enhanced by the numbering up strategy. Second, as the time now is not limited to the reactor volume, a limitless high flow rate may be set. The extremely high flow velocity can overcome solid sedimentation to avoid clogging, therefore thereby enabling heterogeneous photocatalysis in flow.

As used herein, a “catalyst” a substance that increases the rate of a chemical reaction without itself undergoing any permanent chemical change. As used herein, a “photocatalyst” is a material which absorbs light to bring it to higher energy level and provides such energy to a reacting substance to catalyse a chemical reaction occur. “Heterogeneous catalyst” refers to a catalyst whose physical phase is different from the physical phase of the reactants and/or products that take part in the catalysed chemical reaction. Such catalyst can be used to facilitate chemical reactions between two gaseous reactants, two liquid reactants, or a gaseous reactant and a liquid reactant.

The tubing reactor may be configured to run spirally and circumferentially along a longitudinal axis. In this regard, the tubing of the tubing reactor runs circumferentially and along a lateral curved surface area of a cylinder. This allows the flow of the reactant and/or heterogeneous catalyst to be maintained in a laminar flow.

In some embodiments, the micro-flow system is formable as a closed loop. In some embodiments, the micro-flow system may be toggled between an open loop and a closed loop. When the loop is closed, the reaction mixture of the reactant and/or heterogeneous catalyst may be re-circulated through the tubing reactor until the reaction is sufficiently or substantially completed. This maintains all the benefits associated with micro-tubing reactors, such as the excellent light penetration, improved mass and heat transfer, and enhanced safety.

In some embodiments, the tubing reactor has a cylindrical conformation. The cylinder may have an outer diameter of about 10 cm to about 100 cm, about 15 cm to about 100 cm, about 20 cm to about 100 cm, about 30 cm to about 100 cm, about 40 cm to about 100 cm, or about 50 cm to about 100 cm. The cylinder may have a height of about 10 cm to about 100 cm, about 15 cm to about 100 cm, about 20 cm to about 100 cm, about 30 cm to about 100 cm, about 40 cm to about 100 cm, or about 50 cm to about 100 cm. For example, the cylinder may have an outer diameter of about 30 cm and a height of about 30 cm.

The micro-flow system may comprise one tubing reactor, or a plurality of tubing reactors. The plurality of tubing reactors may be arranged sequentially or in parallel.

In some embodiments, the tubing reactor is characterised by a volume of about 50 mL to about 1000 mL. In other embodiments, the volume is about 60 mL to about 1000 mL, about 70 mL to about 1000 mL, about 80 mL to about 1000 mL, about 90 mL to about 1000 mL, about 90 mL to about 900 mL, about 90 mL to about 800 mL, about 90 mL to about 700 mL, about 90 mL to about 600 mL, about 90 mL to about 500 mL, or about 90 mL to about 400 mL. In some embodiments, the tubing reactor is characterised by a volume of about 90 mL to about 850 mL.

In some embodiments, the tubing reactor is characterised by an inner diameter of about 1 mm to about 10 mm. In other embodiments, the inner diameter of about 2 mm to about 10 mm, about 3 mm to about 10 mm, about 4 mm to about 10 mm, about 4 mm to about 9 mm, about 4 mm to about 8 mm, about 4 mm to about 7 mm, or about 4 mm to about 6 mm. In some embodiments, the tubing reactor is characterised by an inner diameter of about 5 mm.

In some embodiments, the tubing reactor comprises a tubing, the tubing comprising a material selected from perfluoroalkoxy alkane (PFA), ethylene-tetra-fluoro-ethylene (ETFE), poly (ether-ether-ketone) (PEEK), poly-tetra-fluoroethylene (PTFE), polyvinylidene difluoride (PVDF), fluorinated ethylene propylene (FEP, Teflon®), stainless steel (SS), Viton®, Norprene®, silicon carbide (SIC), EPDM rubber, glass, or a combination thereof. In some embodiments, the tubing reactor comprises a perfluoroalkoxy alkane (PFA) tubing.

In some embodiments, the actuator is a peristaltic pump.

In some embodiments, the heterogeneous catalyst is selected from mesoporous graphitic carbon nitride, insoluble inorganic salts/oxide powders such as titanium dioxide, immobilized heavy metals such as palladium on carbon, single-atom catalysts such as single-atom palladium distributed in titanium dioxide, catalysts immobilized on resin such as resin supported enzymes, inorganic nanoparticles, conjugated microporous polymers (CMP), covalent organic frameworks (COFs), metal organic frameworks (MOFs), hydrogen-bonded organic frameworks (HOFs), or a combination thereof. In some embodiments, the heterogeneous catalyst is mesoporous graphitic carbon nitride.

In some embodiments, the heterogeneous catalyst is characterised by a particle size of about 10 nm to about 10 mm. In other embodiments, the particle size is about 10 nm to about 8 mm, about 10 nm to about 6 mm, about 10 nm to about 5 mm, about 10 nm to about 4 mm, about 10 nm to about 2 mm, about 10 nm to about 1 mm, about 10 nm to about 0.5 mm, about 10 nm to about 0.1 mm, about 20 nm to about 0.1 mm, about 40 nm to about 0.1 mm, about 60 nm to about 0.1 mm, about 80 nm to about 0.1 mm, about 100 nm to about 0.1 mm, or about 500 nm to about 0.1 mm. For larger size particles, grinding or pulverization can be used to easily obtain finer particles for the reaction.

In some embodiments, the heterogeneous catalyst is characterised by a concentration of about 20 mg/mL to about 200 mg/mL. In other embodiments, the concentration is about 40 mg/mL to about 200 mg/mL, about 60 mg/mL to about 200 mg/mL, about 70 mg/mL to about 200 mg/mL, about 100 mg/mL to about 200 mg/mL, about 120 mg/ml to about 200 mg/mL, about 140 mg/ml to about 200 mg/mL, or about 160 mg/mL to about 200 mg/mL.

In some embodiments, the heterogeneous catalyst is dispersed on a solid support. In this regard, the heterogeneous catalyst is supported on or adhered to the solid support. The solid support may increase the surface area (spread the number of active sites) and provide stability to the heterogeneous catalyst. Solid supports may be inert, high melting point materials, but they may also be catalytic themselves. Solid supports may also be a porous material (such as carbon, silica, zeolite, or alumina-based) with a high surface area-to-mass ratio. In other embodiments, the solid support is glass beads. Glass beads may intensify the light penetration. Commercially available glass beads with very small particle size are also available and suitable for use.

As used herein, ‘solid support’ refers to a non-soluble material, the surface of which can be used to synthesise a compound. In this regard, the solid support can be a polymeric resin bead. A solid support can be made up of materials such as polystyrene, polystyrene-PEG composites, PEG and poly-ε-lysine (ε-PL). Such a solid support can be functionalized with reactive groups (such as amine or hydroxyl groups). The solid support can be characterised by its loading level and swelling capacity in organic solvents. In this regard, the physical aspects of the solid support such as composition, bead size, and chemical aspects such as functionalisation can influence its use and downstream chemistry.

For example, the heterogeneous catalyst on a solid support may be palladium on carbon.

In some embodiments, the solid support is characterised by a particle size of about 100 nm to about 100 mm. In other embodiments, the particle size is about 100 nm to about 80 mm, about 100 nm to about 60 mm, about 100 nm to about 50 mm, about 100 nm to about 40 mm, about 100 nm to about 20 mm, about 100 nm to about 10 mm, about 100 nm to about 5 mm, about 100 nm to about 1 mm, about 200 nm to about 1 mm, about 400 nm to about 1 mm, about 600 nm to about 1 mm, about 800 nm to about 1 mm, about 1000 nm to about 1 mm, about 1200 nm to about 1 mm, or about 1500 nm to about 1 mm. For larger size particles, grinding or pulverization can be used to easily obtain finer particles for the reaction.

In some embodiments, the solid support is characterised by a catalyst loading of about 1 wt/wt % to about 10 wt/wt %. In other embodiments, the catalyst loading is about 1.5 wt/wt % to about 10 wt/wt %, about 2 wt/wt % to about 10 wt/wt %, about 2.5 wt/wt % to about 10 wt/wt %, about 3 wt/wt % to about 10 wt/wt %, about 3.5 wt/wt % to about 10 wt/wt %, about 4 wt/wt % to about 10 wt/wt %, about 4.5 wt/wt % to about 10 wt/wt %, about 5 wt/wt % to about 10 wt/wt %, about 5.5 wt/wt % to about 10 wt/wt %, about 6 wt/wt % to about 10 wt/wt %, about 6.5 wt/wt % to about 10 wt/wt %, about 7 wt/wt % to about 10 wt/wt %, about 7.5 wt/wt % to about 10 wt/wt %, or about 8 wt/wt % to about 10 wt/wt %.

In some embodiments, the system further comprises a homogeneous catalyst. Homogeneous catalysis is catalysis by a soluble catalyst in a solution. Homogeneous catalysis refers to reactions where the catalyst is in the same phase as the reactants, principally in solution. In some embodiments, the homogeneous catalyst is NiCl₂.glyme. Any homogeneous catalyst may be applied in this micro-flow system.

In some embodiments, the micro-flow system further comprises a light source, the light source tubing reactor coupled to a light source. The light source is for photocatalysing the reactant in the presence of the heterogeneous catalyst. In this regard, the heterogeneous catalyst is a heterogeneous photocatalyst. Photocatalysis is the acceleration of a photoreaction in the presence of a catalyst.

Accordingly, in some embodiments, the micro-flow system for synthesis of a compound comprises:
a) a tubing reactor coupled to a light source, the tubing reactor configured to flow a reactant within its lumen thereof;
b) an actuator for regulating the flow of the reactant in the lumen; and
c) a heterogeneous photocatalyst in fluid communication with the lumen;

wherein the heterogeneous photocatalyst is configured to flow in tandem with the reactant in order to catalyse the reactant to form the compound; and

wherein the reactant and the heterogeneous photocatalyst are configured to flow within the lumen of the tubing reactor for more than one cycle.

When a light source is used, the tubing in the tubing reactor is adapted to allow light to penetrate its walls in order to photocatalyse the reaction. In this regard, perfluoroalkoxy alkane (PFA) may be preferred. Alternatively, a combination of tubing materials can be used. For example, the tubing reactor may comprise stainless stain tubings, with windows at appropriate locations. The windows may be formed from PFA or glass.

In some embodiments, the light source is positioned adjacent to a longitudinal axis of the tubing reactor. The light source may be positioned adjacent to an external surface formed by the tubing reactor. The light source may be arranged to lie on a circumference of a circle which center is aligned with the longitudinal axis of the tubing reactor, and which the diameter of the circle is larger than a diameter of the tubing reactor. If multiple light sources are used, the light sources may be positioned at equidistance relative to each other and to the longitudinal axis. Multiple light sources may be used to ensure the uniformity of illumination in the system. The number of light sources may be adjusted based on the height of the tubing reactor. In some embodiments, the light source is positioned adjacent to and circumferentially to the tubing reactor.

In some embodiments, the light source is a LED. In other embodiments, the light source provides at least 300 W of light to the tubing reactor. In some embodiments, the light source is a plurality of 64 W LED. As the light sources may be modular, each with a power of 64 W, reactions of different scales may be easily scaled by adjusting the number of light sources required.

In some embodiments, the light source is configured to provide a light intensity of at least 60,000 cd. In other embodiments, the light intensity is at least 70,000 cd, 80,000 cd, 90,000 cd, 120,000 cd, 180,000 cd, 240,000 cd, 30,000 cd, 360,000 cd, 420,000 cd, or 480,000 cd. If LED light source is used, LEDs have high conversion efficiency, usually producing 100 lumens of illumination per watt. For the 300 W reactor model, the overall luminous flux produced is 30,000 lumens. The side area of the cylinder is about 2500 square centimetres, and the light source utilization is calculated at 80%.

In some embodiments, the micro-flow system for synthesis of a compound comprises:
a) a tubing reactor coupled to a light source, the tubing reactor configured to flow a reactant and a homogeneous catalyst within its lumen thereof;
b) an actuator for regulating the flow of the reactant in the lumen; and
c) a heterogeneous photocatalyst in fluid communication with the lumen;

wherein the heterogeneous photocatalyst is configured to flow in tandem with the reactant in order to catalyse the reactant and the homogeneous catalyst to form the compound; and

wherein the reactant, the homogeneous catalyst and the heterogeneous photocatalyst are configured to flow within the lumen of the tubing reactor for more than one cycle.

In some embodiments, the micro-flow system further comprises a controller configured to regulate the flow of the reactant and the heterogeneous catalyst. The controller can be a computer. The computer may be configured to be electrically connected to the actuator so as to regulate the flow of the reactant and/or heterogeneous catalyst. Alternatively, the controller may be remotely in communication with the actuator.

In some embodiments, the micro-flow system further comprises a reaction reservoir for collecting the reactant and heterogeneous catalyst from the tubing reactor and re-circulating the reactant and heterogeneous catalyst back to the tubing reactor. The reaction reservoir serves as a catchment to pool together reactant and heterogeneous catalyst that flows out from the tubing reactor. This allows the reaction mixture to be independently and homogeneously mixed before being returned to the tubing reactor. This may provide a higher yield with high purity.

In some embodiments, the micro-flow system further comprises a collection reservoir for collecting the compound. In this regard, the micro-flow system may comprise a valve which directs the flow out of the tubing reactor towards to the collection reservoir when switched. The collection reservoir serves to collect the final compound after the reaction is completed.

In some embodiments, the micro-flow system further comprises at least one multi-port valve. The valve may be a 2 way, 3 way or 4 way valve. The valve may be used to toggle the micro-flow system from an open system to a closed system, thus allowing the heterogenous catalyst and reactant to circulate the tubing reactor for more than one cycle. A single valve or different valves may be used to control the flow to the reaction reservoir, waste or the collection reservoir.

In some embodiments, the valve is controllable by a controller. The controller may be configured to actuate the valve to regulate and/or switch the flow.

The flow to the reaction reservoir or the collection reservoir may be controlled by a 2 way valve or 3 way valve. This valve may in turn be controlled by a controller. The controller may be configured to actuate the at least one multi-port input valve for selective flow of the reaction mixture. In this way, the micro-flow system may form a closed loop.

In some embodiments, the micro-flow system further comprises a separator for separating the compound from the heterogeneous catalyst. A frit disc may be used. In this way, the heterogeneous catalyst does not flow into the collection reservoir but is returned to the reaction reservoir, where it can be reused. The heterogeneous catalyst can be recycled and reused by filtration and washing without loss of its catalytic capacity, achieving in total a kilogram-scale synthesis with the same batch of heterogeneous catalyst.

In some embodiments, the micro-flow system further comprises a filter for separating out aggregated particles. For example, during the course of reaction, some of the heterogeneous catalyst may aggregate. If not removed, the aggregates may sediment and clog the system. The filter may be positioned along the flow such that such aggregates may be separated out from the flow, while allowing smaller sized and not aggregated heterogeneous catalyst to flow through. Accordingly, the filter may have a Molecular Weight Cutoff which is suitably sized.

In some embodiments, the micro-flow system further comprises a reactant source, a solvent source, a heterogeneous catalyst source or a combination thereof. The reactant source, a solvent source and a heterogeneous catalyst source may be pumped to the tubing reactor via a second actuator. The second actuator may be in communication with the controller. The micro-flow system may also comprise a gas source. The gas source may be a reactant.

The reactant source, a solvent source, a heterogeneous catalyst source and gas source may flow to the tubing reactor at a different flow rate. This depends on the concentration of the sources and the desired rate of mixing to form the reaction mixture.

In some embodiments, the solvent is an aqueous medium. The term ‘aqueous medium’ used herein refers to a water based solvent or solvent system, and which comprises of mainly water. Such solvents can be either polar or non-polar, and/or either protic or aprotic. Solvent systems refer to combinations of solvents which resulting in a final single phase. Both ‘solvents’ and ‘solvent systems’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water. Water based solvent or solvent systems can also include dissolved ions, salts and molecules such as amino acids, proteins, sugars and phospholipids. Such salts may be, but not limited to, sodium chloride, potassium chloride, ammonium acetate, magnesium acetate, magnesium chloride, magnesium sulfate, potassium acetate, potassium chloride, sodium acetate, sodium citrate, zinc chloride, HEPES sodium, calcium chloride, ferric nitrate, sodium bicarbonate, potassium phosphate and sodium phosphate. As such, biological fluids, physiological solutions and culture medium also falls within this definition.

In other embodiments, the solvent is organic medium. As used herein, the term “organic medium” is an organic based solvent or solvent system, and which comprises of mainly organic solvent. Organic based solvents can be any carbon based solvents. Such solvents can be either polar or non-polar, and/or either protic or aprotic. Solvent systems refer to combinations of solvents which resulting in a final single phase. Both ‘solvents’ and ‘solvent systems’ can include, and is not limited to, pentane, cyclopentane, hexane, cyclohexane, benzene, toluene, dioxane, chloroform, diethylether, dichloromethane, tetrahydrofuran, ethyl acetate, acetone, dimethylformamide, acetonitrile, dimethyl sulfoxide, nitromethane, propylene carbonate, formic acid, butanol, isopropanol, propanol, ethanol, methanol, acetic acid, ethylene glycol, diethylene glycol or water. Organic based solvents or solvent systems can include, but not limited to, any non-polar liquid which can be hydrophobic and/or lipophilic. As such, oils such as animal oil, vegetable oil, petrochemical oil, and other synthetic oils are also included within this definition.

In some embodiments, the micro-flow system is configured to withstand a high flow rate. In some embodiment, the micro-flow system is adaptable to withstand a flow rate of about 20 mL/min to about 1000 mL/min. In some embodiments, the micro-flow system is characterised by a flow rate of about 20 mL/min to about 1000 ml/min. In other embodiments, the flow rate is about 30 mL/min to about 1000 ml/min, about 40 mL/min to about 1000 mL/min, about 40 mL/min to about 900 mL/min, about 40 mL/min to about 800 mL/min, about 40 mL/min to about 700 mL/min, about 40 mL/min to about 600 mL/min, about 40 mL/min to about 500 mL/min, or about 40 mL/min to about 400 mL/min. In some embodiments, the flow rate is at least 30 mL/min.

Aggregation of particles may be prevented with a high flow rate. In some embodiments, the flow rate of the micro-flow system is about 35 mL/min to about 1000 ml/min. In other embodiments, the flow rate is about 35 mL/min to about 800 mL/min, about 35 mL/min to about 600 mL/min, about 35 mL/min to about 400 mL/min, about 40 mL/min to about 1000 mL/min, about 40 mL/min to about 900 mL/min, about 40 mL/min to about 800 mL/min, about 40 mL/min to about 700 mL/min, about 40 mL/min to about 600 mL/min, about 40 mL/min to about 500 mL/min, or about 40 mL/min to about 400 mL/min. In some embodiments, the flow rate is at least 40 mL/min.

In some embodiment, the flow rate of the reactant is about 20 mL/min to about 1000 mL/min. In other embodiments, the flow rate is about 30 mL/min to about 1000 mL/min, about 40 mL/min to about 1000 ml/min, about 40 mL/min to about 900 mL/min, about 40 mL/min to about 800 mL/min, about 40 mL/min to about 700 mL/min, about 40 mL/min to about 600 mL/min, about 40 mL/min to about 500 mL/min, or about 40 mL/min to about 400 mL/min.

In some embodiments, the heterogeneous catalyst is characterised by a flow rate of about 20 mL/min to about 1000 mL/min. In other embodiments, the flow rate is about mL/min to about 1000 mL/min, about 40 mL/min to about 1000 mL/min, about 40 mL/min to about 900 mL/min, about 40 mL/min to about 800 mL/min, about 40 mL/min to about 700 mL/min, about 40 mL/min to about 600 mL/min, about 40 mL/min to about 500 mL/min, or about 40 mL/min to about 400 mL/min. The flow rate of the 30 heterogeneous catalyst may depend on the particle size and shape of the solids, the flow rate of the liquid, the viscosity coefficient of the liquid, etc. This is a nonlinear relationship, and different reagents will lead to different results.

In some embodiments, the flow rate of the reactant relative to the heterogeneous catalyst is about 1.01 to about 10. In other embodiments, the relative flow rate is about 1.05 to about 10, about 1.1 to about 10, about 1.15 to about 10, about 1.2 to about 10, about 1.25 to about 10, about 1.3 to about 10, about 1.35 to about 10, about 1.4 to about 10, about 1.45 to about 10, about 1.5 to about 10, about 1.6 to about 10, about 1.7 to about 10, about 1.8 to about 10, about 1.9 to about 10, about 2 to about 10, about 3 to about 10, about 4 to about 10, about 5 to about 10, about 6 to about 10, about 7 to about 10, or about 8 to about 10. In general, the flow rate of heterogeneous catalyst is lower than flow rate of the reactant. Further, the faster the reactant flow rate, the faster the heterogeneous catalyst flow rate will be.

The flow rate may be influenced by the viscosity of the reaction mixture. In particular, the flow rate is inversely proportional to a viscosity of the reaction mixture (reagent, heterogeneous catalyst and solvent). Accordingly, in order to maintain the flow rate, the pressure difference between two ends should increase proportionally as viscosity increases.

In some embodiments, when the viscosity of the reaction mixture is about 0.4 mPa·s to about 10.0 mPa·s, the flow rate of the micro-flow system is about 40 mL/min to about 1000 mL/min. In other embodiments, the flow rate is about 40 mL/min to about 900 mL/min, about 40 mL/min to about 800 mL/min, about 50 mL/min to about 1000 mL/min, about 50 mL/min to about 900 mL/min, about 50 mL/min to about 800 mL/min, about 60 mL/min to about 1000 ml/min, about 60 mL/min to about 900 mL/min, or about 60 mL/min to about 800 mL/min. In general, the higher the viscosity of the reaction mixture, the higher the flow rate used for the micro-flow system.

In some embodiments, the micro-flow system further comprises cooling means. The cooling means cools down the reaction mixture to minimise the formation of side products.

In some embodiments, the micro-flow system further comprises heating means. The heating means may heat up the reactants and/or solvent in the lumen of the tubing reactor.

In some embodiments, the micro-flow system is adaptable to catalyse a C-N coupling, C-S coupling and/or Minisci reaction. The Minisci reaction is a nucleophilic radical substitution to an electron deficient aromatic compound, most commonly the introduction of an alkyl group to a nitrogen containing heterocycle. In other embodiments, the micro-flow system is adaptable to photocatalyse a reaction. The reactant may be a photolabile reactant. The reactant may be susceptible to a change under the influence of radiant energy and especially of light. For example, the reaction may comprise a reactant having an amino moiety and aryl or alkenyl halide. The reaction may comprise a reactant having a thiol moiety and aryl or alkenyl halide. The reaction may be a nucleophilic radical substitution to an electron deficient aromatic compound, for example the introduction of an alkyl group to a nitrogen containing heterocycle.

The micro-flow system can be scaled up from a 10 g scale, to a 100 g scale, to a 1 kg scale, and more.

In some embodiments, the micro-flow system for synthesis of a compound, comprises:
a) a tubing reactor configured to flow a reactant from a reactant source within its lumen thereof;
b) an actuator for regulating the flow of the reactant in the lumen;
c) a heterogeneous catalyst in fluid communication with the lumen;
d) a solvent source in fluid communication with the lumen; and
e) a collection reservoir in fluid communication with the lumen;
f) at least one multi-port valve configured to control the flow of reactant in the tubing reactor, reactant source, solvent source and/or collection reservoir;

wherein the heterogeneous catalyst is configured to flow in tandem with the reactant in order to catalyse the reactant to form the compound; and

wherein the reactant and the heterogeneous catalyst are configured to flow within the lumen of the tubing reactor for more than one cycle.

In some embodiments, the at least one multi-port valve is configured to toggle the micro-flow system between an open loop and a closed loop.

The present invention also provides a method of micro-flow synthesising a compound using a micro-flow system, the micro-flow system comprising:
a) a tubing reactor configured to flow a reactant within its lumen thereof;
b) an actuator for regulating the flow of the reactant in the lumen; and
c) a heterogeneous catalyst in fluid communication with the lumen;

wherein the heterogeneous catalyst is configured to flow in tandem with the reactant in order to catalyse the reactant to form the compound; and

wherein the reactant and the heterogeneous catalyst are configured to flow within the lumen of the tubing reactor for more than one cycle;

the method comprising:
a) flowing the reactant at a flow rate of about 20 mL/min to 1000 mL/min; and
b) catalysing the reactant in the presence of the heterogeneous catalyst in order to synthesise the compound.

By flowing the reaction mixture at a high velocity, solid sedimentation can be overcome to avoid clogging, enabling even improved mixing efficiency, and improved reproducibility.

In some embodiments, the method of micro-flow synthesising a compound uses a micro-flow system, the micro-flow system comprising:
a) a tubing reactor coupled with a light source, the tubing reactor configured to flow a reactant within its lumen thereof;
b) an actuator for regulating the flow of the reactant in the lumen; and
c) a heterogeneous photocatalyst in fluid communication with the lumen;

wherein the heterogeneous photocatalyst is configured to flow in tandem with the reactant in order to catalyse the reactant to form the compound; and

wherein the reactant and the heterogeneous photocatalyst are configured to flow within the lumen of the tubing reactor for more than one cycle;

the method comprising:
a) flowing the reactant at a flow rate of about 20 mL/min to 1000 mL/min; and
b) catalysing the reactant in the presence of the heterogeneous photocatalyst in order to synthesise the compound.

In some embodiments, the method of synthesising a compound is a method of synthesising a small molecule compound. A small molecule is a low molecular weight (<900 daltons) organic compound that may regulate a biological process, with a size on the order of 1 nm. Peptide and proteins are excluded from this definition.

In some embodiments, the method further comprises a step of washing the heterogeneous catalyst. In some embodiments, the method further comprises a step of conditioning the heterogeneous catalyst.

As used herein, “conditioning” includes a step of washing the heterogeneous catalyst with a solvent. This washing step is preferably done before the reaction step. The solvent can be a solvent that is the same or similar to that used in the reaction. For example, if DMF is used in the reaction, the conditioning step includes washing the heterogeneous catalyst with DMF, after which the reaction on the heterogeneous catalyst is performed in DMF.

In some embodiments, the method is adaptable to catalyse a C-N coupling, C-S coupling and/or Minisci reaction.

The present invention is particularly applicable to the synthesis of Bipenamol.

### EXAMPLES

### Circulation Flow Reactor

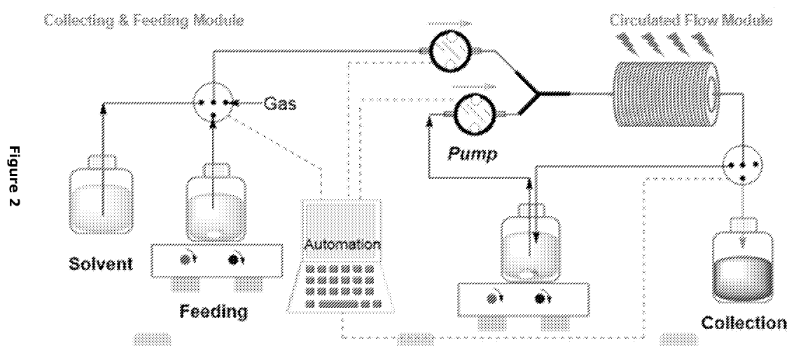

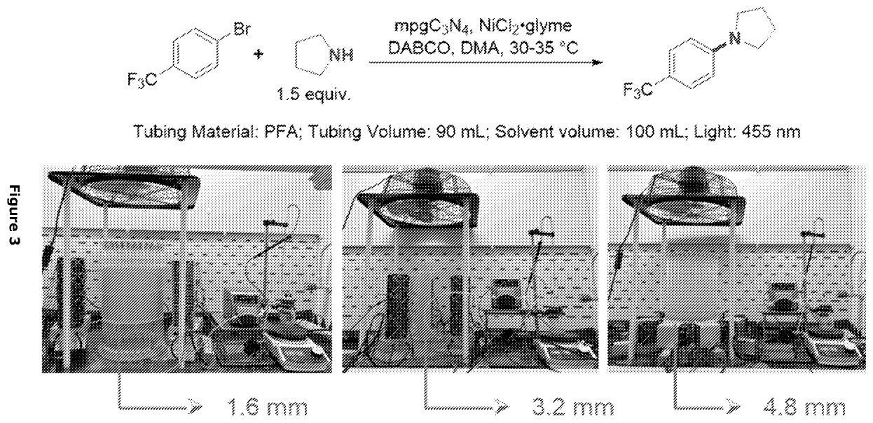

As shown in FIG. 2, the circulation flow reactor includes (among others) components such as a peristaltic pump, multi-position valves, light panels, magnetic stirrer, and perfluoroalkoxy (PFA) tubing. The reactor may be controlled by a computer. The circulated flow allows for scalable processes. The circulated flow path allows for long-time reactions. The reactor can be configured to have a high flow rate to avoid clogging. It can also be configured to integrate gas into the process. Heterogeneous photocatalysts may be used in the reactor and can be recycled and reused. The reactor may have automated feeding and collecting of reaction slurry and reaction mixture, enabling continuous processing.

In operation, the peristaltic pump delivers the reaction slurry into the PFA tubing at very high rate to avoid solid sedimentation. The reaction mixture is circulated back to the reaction reservoir to re-enter the tubing reactor until the reaction is completed. A computer may be used to automate the synthesis. For example, multi-position valves may be switched to direct the flow into reaction reservoir, or to a collection reservoir when the reaction is completed. The synthesis may also be automated to absorb the fresh slurry or washing solvent from the feeding or solvent reservoir.

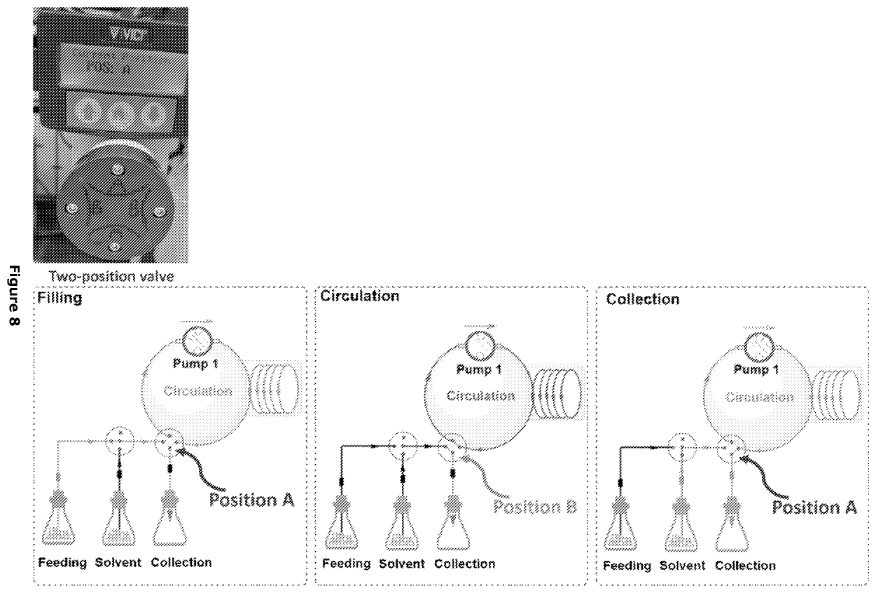

There are two flow modes in the circulation flow synthesis of the present invention. The reaction mixture may be circulated back to the reaction reservoir and re-circulated through the tubing reactor until the reaction is completed (FIG. 8). This maintains all the benefits associated with micro-tubing reactors, such as the excellent light penetration, improved mass and heat transfer, and enhanced safety. Alternatively, the reaction mixture may be circulated in the tubing loop and ejected to a collection reservoir after the reaction is completed (FIG. 8). This allows the reaction to become batchwise, and the reaction time is not limited to the reactor volume which can be performed as long as needed until it finishes, thus enabling slow reactions in a flow mode.

The reaction scale may be limited by the tubing volume, which may be overcome by filling in new sets of reagents and starting materials into the reservoir to start another batch, achieving continuous production via automated feeding and collection. Since the system is compact and modular, the scale may be further enhanced by the numbering up strategy.

The micro-flow synthesis can be configured to have a flow rate which is extremely high as the time is not limited by the reactor volume. The flow rate may only limited by the max flow rate of the pump. The extremely high velocity can overcome solid sedimentation to avoid clogging, enabling even improved mixing efficiency, improved reproducibility, and heterogeneous photocatalysis in flow.

The circulated flow mode may be integrated with fully-automated controls. This further enhances the processing capability of circulation flow reactor and can integrate with in-line detection and monitoring means.

### Investigation of Circulation Flow Reactor for Heterogeneous Photocatalysis

Compared to homogeneous photocatalysis, heterogeneous photocatalysis is much less explored in organic synthesis, and one of the hurdles is the difficult for scaling up. Polymeric carbon nitrides (PCNs) are among the most appealing heterogeneous catalysts for photocatalysis and have witnessed significant development during the past decade, due to their metal-free and inexpensive characters, tunable bandgaps, with excellent chemical-and photo-stability. A nickel/mesoporous graphite carbon nitride (mpg-CN) photo-mediated C-N coupling first reported by König was chosen as a model reaction to investigate the feasibility of heterogeneous photocatalysis in a flow fashion, as this dual catalytic reaction embraces enormous industrial interests by achieving a ligand-free Buchwald-Hartwig type C-N coupling at ambient conditions. However, when first attempted to perform this reaction in a capillary packed with mpg-CN, a very low yield of product was obtained with a significant amount of Ni-black generated which contaminated the photocatalyst after an hour operation, blocking the light penetration. Introducing argon gas to form a gas-liquid-solid suspension flow to mimic the serial micro-batch reactor was also unsuccessful, with 5% conversion and 4% yield achieved due to the short residence time, reducing the velocity to prolong the irradiation time up to 5 hours was less helpful, with 12% conversion and 7% yield.

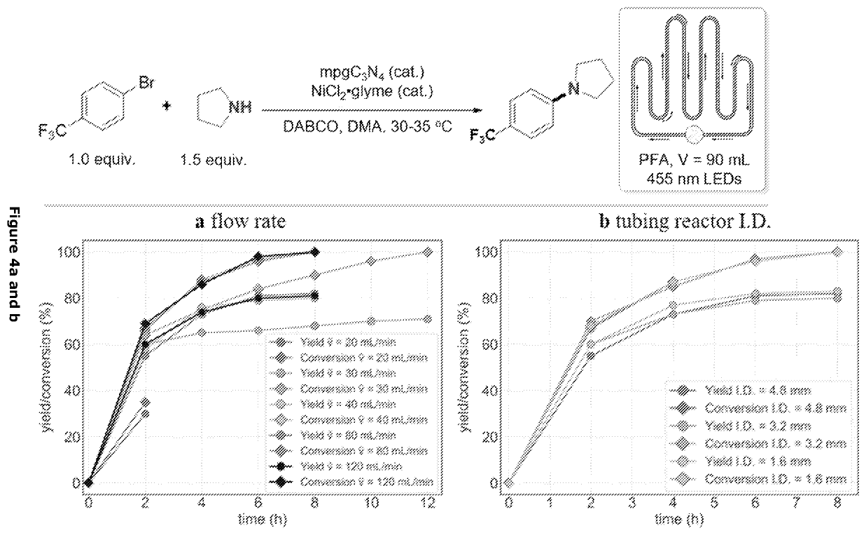

A build-in-house circulation flow reactor comprising of a reagent/reactant reservoir, a peristaltic pump, a perfluoroalkoxy alkane (PFA) tubing coil and several 64 W LED sets was assembled for a proof-of-concept study (FIG. 3). Different flow rates were examined first to overcome the deposition challenge. At a 10-gram scale, the substrates were first mixed with 5% w/w mpg-CN and 5 mol % NiCl₂.glyme in 100 mL DMA to form a slurry of solid support by stirring. The slurry was continuously pumped through a peristaltic pump at different flow rates to enter a PFA tubing reactor (outer diameter (O.D.)=6.4 mm, inner diameter (I.D.)=4.8 mm, volume (V)=90 mL) which was irradiated by 9 sets of 64 W LEDs. The reaction mixture flowed back to the original reservoir in a circulated mode until reaction finished. We kept the tubing reactor volume at 90 mL to have the majority of reagents in the tubing reactor under light irradiation.

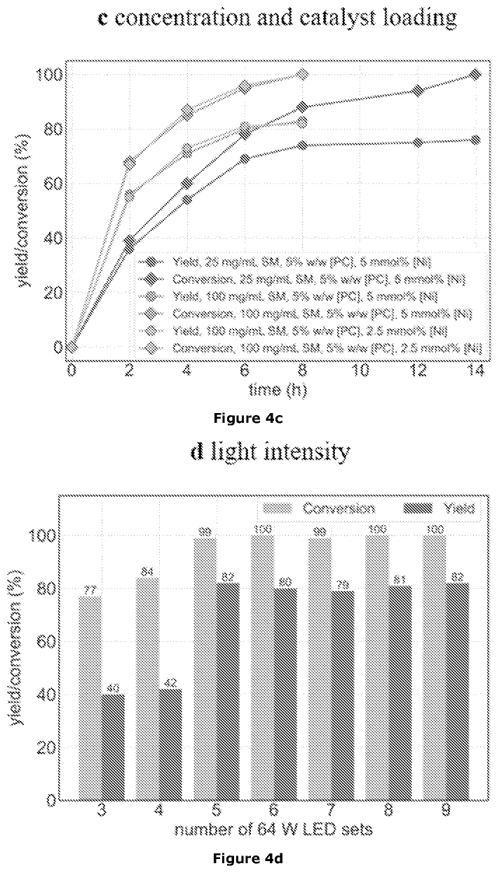

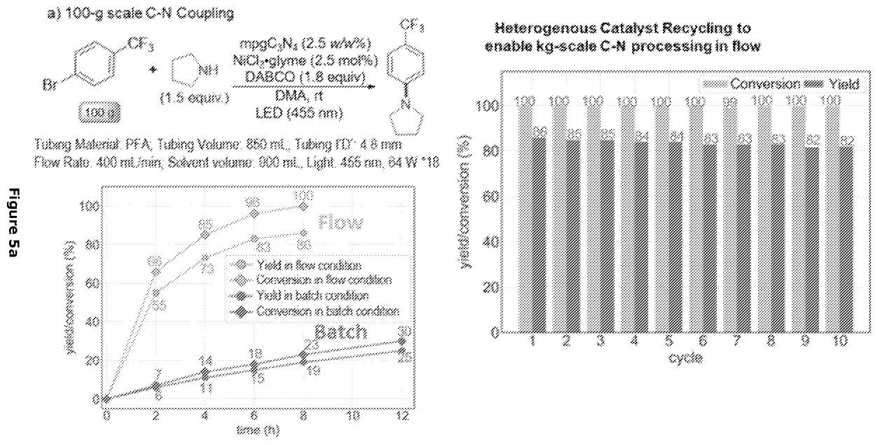

As shown in FIG. 4, when the flow rate was set at 20 mL/min, the flow was discontinued due to clogging after 2-hour running, achieving 35% conversion. At 30 mL/min flow rate, a full conversion was achieved in 12 hours, even though partial aggregation of mpg-CN was observed in the tubing reactor. When the flow rate was increased to 40 mL/min, the aggregation can be fully prevented, achieving full conversion with 8-hour continuous operation. Higher flow rates (80 and 120 mL/min) resulted in smooth flow processes as well, but no further reaction acceleration was observed. Therefore, it is feasible to overcome solid sedimentation and avoid clogging in the tubing reactors simply by flowing at high velocity.

The tubing I.D. is a parameter that may influence the production capacity, mixing efficiency, and light penetration and uniformity. The same reaction mixture was performed in the circulation flow reactors at a flow rate of 80 mL/min with three different tubing sizes (I.D.=1.6 mm, 3.2 mm, 4.8 mm, respectively, FIG. 4b). The results indicated that similar conversions and yields were obtained in these three different tubing reactors, as long as no clogging occurred. Next, the concentration and catalyst loading were investigated (FIG. 4c), where a lower catalyst loading (2.5% w/w mpg-CN and 2.5 mol % NiCl2.glyme) with 10 g/100 mL concentration worked well in the circulation flow reactor. The number of 64 W LED lamps may be reduced from 9 to 5 without affecting the reactivity (FIG. 4d). However, 3 or 4 lamps led to obvious decline of the reaction efficiency, thus the reaction may have to be performed for a longer duration to achieve higher conversions.

### Scaling Up of Heterogeneous Photocatalytic C-N, C-S and Minisci (C-C) Reactions

Investigations above allowed an understanding of the influences in the circulation flow reactor of flow rate, tubing I.D., concentration and catalyst loading and light intensity on PCNs-photocatalysis processes, guiding the assembly and the operating of the reactor for 100-g scale processing.

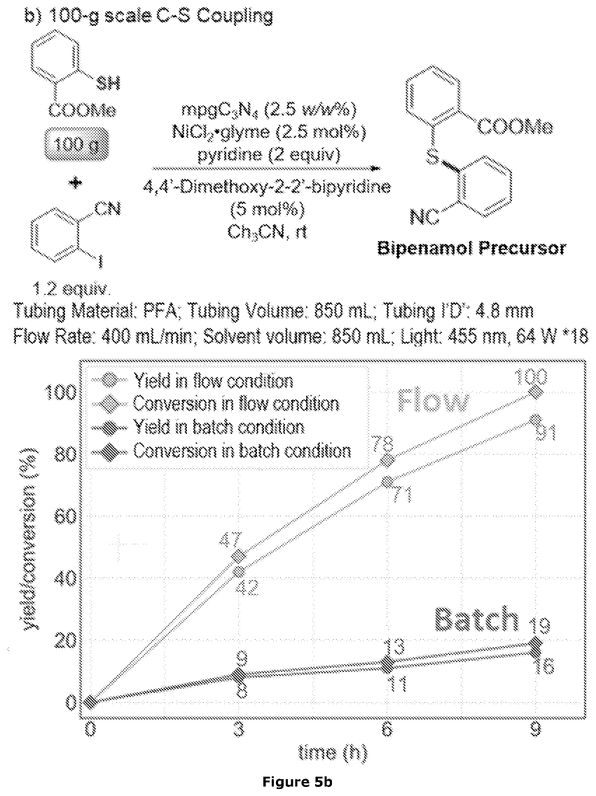

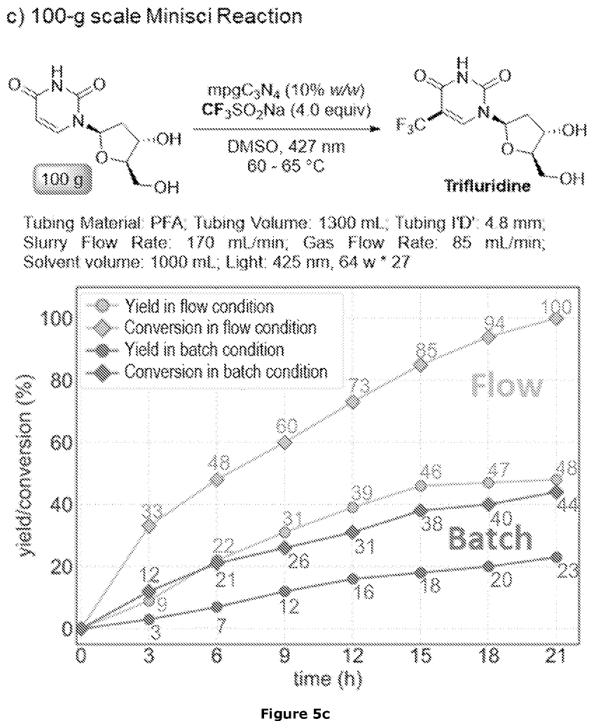

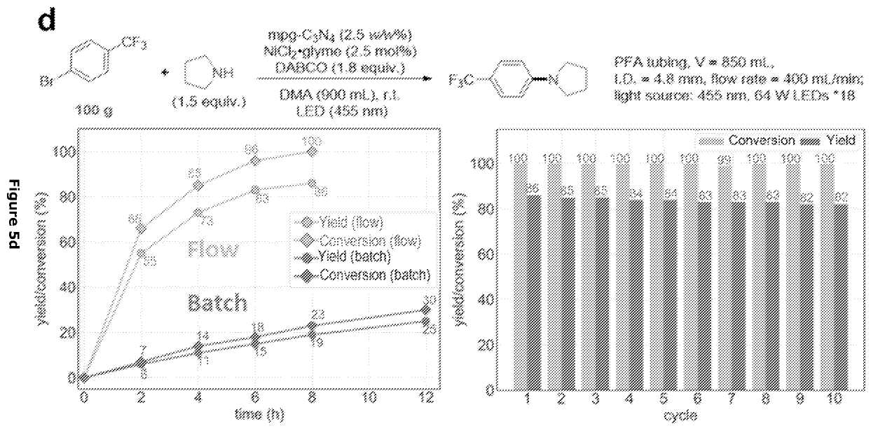

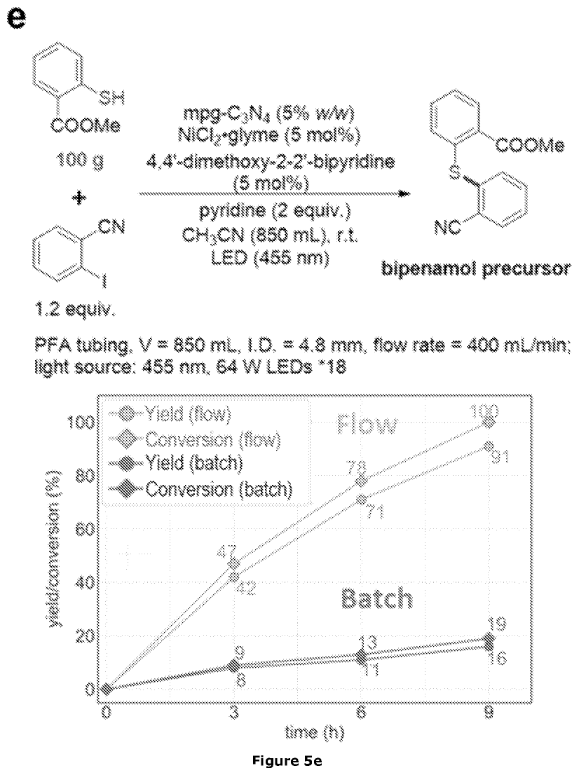

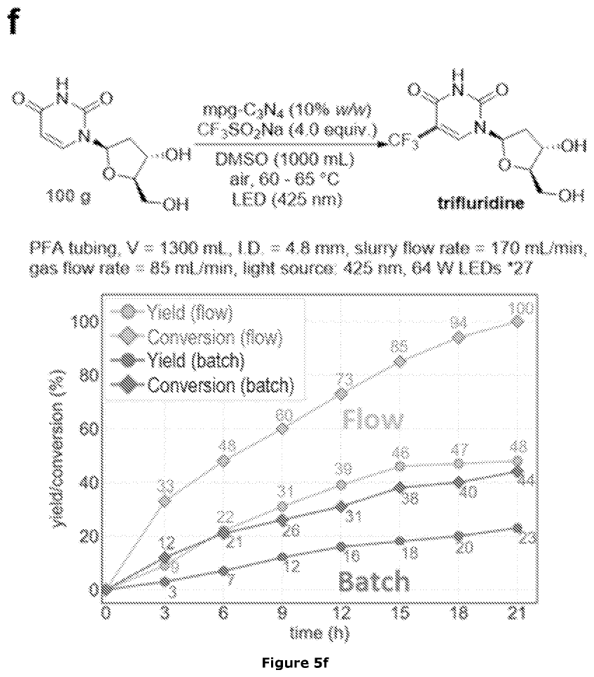

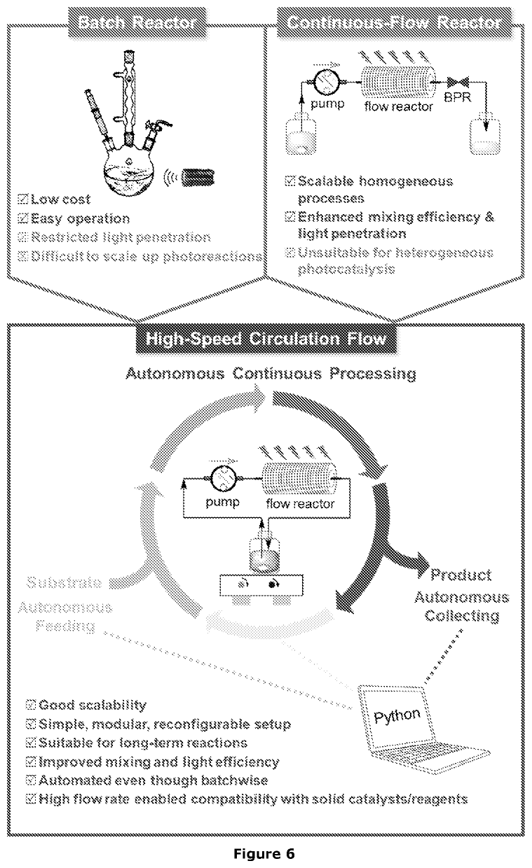

The model C-N coupling reaction was scaled up to 100 g smoothly within a circulation flow reactor of 850 mL PFA tubing, running at 400 mL/min, solvent volume of 1000 mL, and 18 sets of 455 nm light source at 64 W each. The reaction reached the full conversion in 8 hours (FIG. 5d, left), without decline of product yield compared with 10-g scale processing. Notably, when the same scale reaction was conducted in a conventional batch reactor, only 30% conversion was obtained after 12 h, demonstrating that the circulation flow reactor is approximately 10 times more efficient than the batch reactor. Kg-scale processing was also achieved via integration with mpg-CN recycling (FIG. 5a). The heterogeneous mpg-CN photocatalyst can be recycled and reused by simple filtration and washing for at least 10 runs in the C-N coupling reaction without loss of its catalytic capacity, achieving in total a kilogram-scale synthesis with the same batch of photocatalyst (FIG. 5d, right). The same reactor has been verified versatile for 100-g scale heterogeneous photocatalytic C-S coupling, producing the precursor of pharmaceutical molecule-Bipenamol (FIG. 5b and FIG. 5e). The high-speed circulation flow showed a significantly higher reaction rate compared to the conventional batch synthesis, owing to the enhanced light irradiation and excellent mixing efficiency. The established circulation flow reactor was easy to be reconfigured for a gas/liquid/solid triphasic photocatalytic oxidative trifluoromethylation reactions: Introduction of another peristaltic pump for air delivery allowed for the 100-g scale photocatalytic Minisci reaction to yield 57 gram of isolated drug trifluridine (FIG. 5c and FIG. 5f). The reaction was set up with an air flow rate of 170 mL/min, reactant flow rate of 170 mL/min, a circulation flow reactor of 1300 mL PFA tubing, solvent volume of 1000 mL, and 27 sets of 425 nm light source at 64 W each. Notably, the comparisons of these three reactions at the same scale between batchwise and flow-wise further highlighted the capability of circulation flow reactor. The reaction in a circulation flow reactor constantly gave significantly improved efficiency compared to the conventional batch reactor. A photo-promoted gas/liquid/solid three-phase trifluoromethylation reaction has been achieved to produce drug trifluridine at a kg-scale.

### Enabling Kilogram-Scale Continuous Production in an Automated Fashion

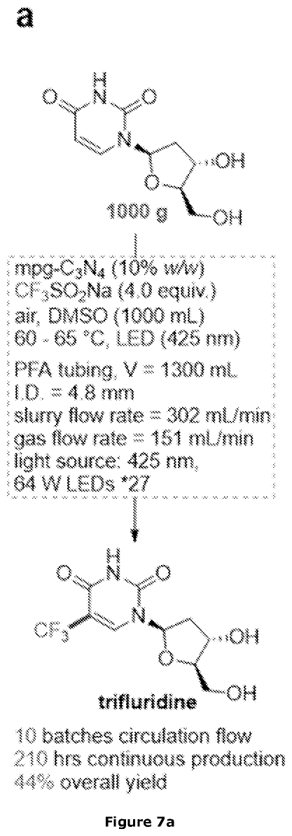

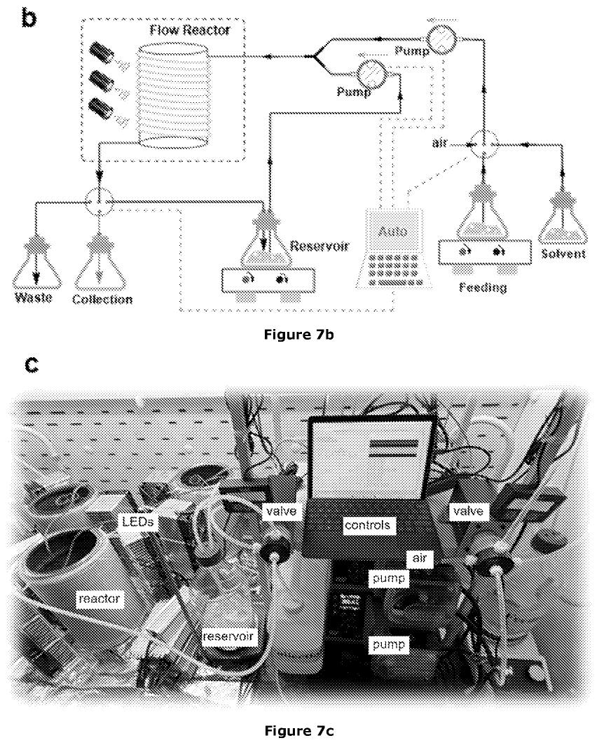

Transition from manual to automated synthesis of chemicals allows improvements in efficiency, cost reductions, on-demand production, and better reproducibility towards good manufacturing practice (GMP) processes. However, automation based on conventional batch reactors normally requires sophisticate control systems with huge investment in specialized facilities. Even though continuous flow processing enables easy automation due to the continuous nature of experiments and the ease of automating unit operations, the incompatibility of solids significantly limited the reaction patterns that can be applied. The high-speed circulation flow system may serve as an excellent platform for automated synthesis, which inherits the merits from continuous micro-flow reactors while resolving the solid clogging issues. The reaction may additionally become batchwise, and continuous production can be simply achieved via automated feeding and collection through the controlling of pumps and valves. To demonstrate its feasibility, the 100-g Minisci-type trifluoromethylation circulation flow system was further equipped with a reagent feeding container, a solvent feeding container, a product collecting bottle, a waste collection bottle, and an additional set of valve and pump. The automation was achieved by Python programming, which controls the pumps and valves that specified the air, solvent, and slurry flow paths (FIGS. 7b and 7c). An automated continuous 210 h production under 425 nm LED light irradiation with 1 kg starting materials afforded the product trifluridine in an overall 44% yield (FIG. 7a), which gave constant results over 10 batches of circulation flow syntheses. No clogging occurred during the entire reaction process, demonstrating the robustness of this system. The catalyst could be recovered and reused. These results clearly indicate the potential of scalable on-demand production of value-added compounds using this simple platform.

Conclusions

We have demonstrated 100 g-scale C-N, C-S, and C-C cross-couplings through heterogeneous photocatalysis in a simple house-build high-speed circulation flow reactor, which significantly outperforming the conventional batch reactors. The photocatalyst may be recycled and reused for at least 10 times. A kilogram scale gas/liquid/solid three-phase photochemical synthesis was achieved by automated continuous 210 h production to give drug trifluridine in an overall 44% yield. The high-speed circulation flow reactor represents an overlooked technology which can better support the synthetic community in taking full advantage of heterogeneous photocatalysis in a scalable fashion. Owing to its simple infrastructure and operation, the excellent efficiency of mixing, heating, and light irradiation, overcoming the clogging issues, effectiveness to slow reactions, and ease to scale up and achieve automation, the high-speed circulation flow reactor promises to become an important method to supplement the current reaction setup, allowing chemists to expand the chemical territory available for synthesis in synthetic laboratories.

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the claims which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A micro-flow system for synthesis of a compound, comprising:
a) a tubing reactor configured to flow a reactant within its lumen thereof;
b) an actuator for regulating the flow of the reactant in the lumen;
c) a heterogeneous catalyst in fluid communication with the lumen; and
d) a valve for configuring the micro-flow system into a closed loop,
wherein the heterogeneous catalyst is configured to flow in tandem with the reactant in order to catalyse the reactant to form the compound;
wherein the reactant and the heterogeneous catalyst are configured to flow within the lumen of the tubing reactor for more than one cycle.

2. The micro-flow system according to claim 1, wherein the micro-flow system is formable as a closed loop when the reactant is catalysed to form the compound.

3. The micro-flow system according to claim 1, wherein the tubing reactor is characterised by a volume of about 50 mL to about 1000 mL, preferably about 90 mL to about 850 mL.

4. The micro-flow system according to claim 1, wherein the tubing reactor is characterised by an inner diameter of about 1 mm to about 10 mm.

5. The micro-flow system according to claim 1, wherein the tubing reactor comprises a tubing, the tubing comprising a material selected from perfluoroalkoxy alkane (PFA), ethylene-tetra-fluoro-ethylene (ETFE), poly (ether-ether-ketone) (PEEK), poly-tetra-fluoroethylene (PTFE), polyvinylidene difluoride (PVDF), fluorinated ethylene propylene (FEP, Teflon®), stainless steel (SS), Viton®, Norprene®, silicon carbide (SiC), EPDM rubber, glass, or a combination thereof.

6. The micro-flow system according to claim 1, wherein the actuator is a peristaltic pump.

7. The micro-flow system according to claim 1, wherein the heterogeneous catalyst is selected from mesoporous graphitic carbon nitride, insoluble inorganic salts/oxide powders such as titanium dioxide, immobilized heavy metals such as palladium on carbon, single-atom catalysts such as single-atom palladium distributed in titanium dioxide, catalysts immobilized on resin such as resin supported enzymes, inorganic nanoparticles, conjugated microporous polymers (CMP), covalent organic frameworks (COFs), metal organic frameworks (MOFs), hydrogen-bonded organic frameworks (HOFs), or a combination thereof.

8. The micro-flow system according to claim 1, wherein the heterogeneous catalyst is characterised by a particle size of about 10 nm to about 10 mm; and/or
wherein the heterogeneous catalyst is characterised by a concentration of about 20 mg/mL to about 200 mg/mL.

9. (canceled)

10. The micro-flow system according to claim 1, wherein the heterogeneous catalyst is dispersed on a solid support; and
wherein the solid support is characterised by a catalyst loading of about 1 wt/wt % to about 10 wt/wt %.

11. (canceled)

12. The micro-flow system according to claim 1, wherein the system further comprises a homogeneous catalyst.

13. The micro-flow system according to claim 1, wherein the heterogeneous catalyst is a heterogeneous photocatalyst; and
wherein the tubing reactor is coupled to a light source for photocatalysing the reactant in the presence of the heterogeneous catalyst.

14. (canceled)

15. The micro-flow system according to claim 13, wherein the light source is positioned adjacent to a longitudinal axis of the tubing reactor.

16. The micro-flow system according to claim 13, wherein the light source is a LED; and
wherein the light source is configured to provide at least 300 W of light to the tubing reactor.

17. (canceled)

18. The micro-flow system according to claim 1, wherein the micro-flow system further comprises at least one of the following:
a) a controller configured to regulate the flow of the reactant and the heterogeneous catalyst;
b) a reaction reservoir for collecting the reactant and heterogeneous catalyst from the tubing reactor and re-circulating the reactant and heterogeneous catalyst back to the tubing reactor;
c) a collection reservoir for collecting the compound;
d) at least one multi-port valve for controlling the flow to the reaction reservoir or the collection reservoir;
e) a separator for separating the compound from the heterogeneous catalyst; and
f) a reactant source, a solvent source, a heterogeneous catalyst source, gas source or a combination thereof.

19-23. (canceled)

24. The micro-flow system according to claim 1, wherein the micro-flow system is adaptable to withstand a flow rate of about 20 mL/min to about 1000 mL/min.

25. The micro-flow system according to claim 1, wherein the micro-flow system is adaptable to catalyse a C-N coupling, C-S coupling and/or Minisci reaction.

26. A method of micro-flow synthesising a compound using a micro-flow system according to claim 1,
the method comprising:
a) flowing the reactant at a flow rate of about 20 mL/min to 1000 mL/min; and
b) catalysing the reactant in the presence of the heterogeneous catalyst in order to synthesise the compound.

27. The method according to claim 26, wherein the flow rate of the reactant and/or the heterogeneous catalyst is characterised by a flow rate of about 20 mL/min to about 1000 mL/min.

28. (canceled)

29. The method according to claim 26, wherein the flow rate of the reactant relative to the heterogeneous catalyst is about 1.01 to about 20.

30. The method according to claim 26, wherein the method is adaptable to catalyse a C-N coupling, C-S coupling and/or Minisci reaction.

31. The micro-flow system according to claim 1, wherein the tubing reactor is characterised by an inner diameter of about 3 mm to about 7 mm.
